(19) United States
(12) Patent Application Publication
(10) Pub. No.: US 2005/0117767 A1
(43) Pub. Date: Jun. 2, 2005

(54) Speaker unit

(75) Inventors: Takeshi Ito, Yamagata (JP); Toshihiro Tanno, Yamagata (JP)

Correspondence Address: NIXON & VANDERHYE, PC, 1100 N GLEBE ROAD, 8TH FLOOR, ARLINGTON, VA, 22201-4714, US

(73) Assignees: Pioneer Corporation, Tokyo (JP); Tohoku Pioneer Corporation, Yamagata (JP)

(21) Appl. No.: 10/992,107

(22) Filed: Nov. 19, 2004

(30) Foreign Application Priority Data
Nov. 20, 2003 (JP) 2003-390595

(51) Int. Cl. H04B 1/00; H04R 5/02; H04R 1/02; H04R 9/06

(52) U.S. Cl. 381/333; 381/301; 381/337; 381/338

(57) ABSTRACT

A speaker unit in which an open end of each of acoustic tubes is disposed on an upper surface of a casing is produced. The speaker unit is mounted outside a seat, for example, to an upper position of a backface side of a backrest of the seat via a connecting member or the like. Thereby, the open ends of the acoustic tubes are disposed at a position near both ears of a seated person. Since low-frequency sound can be reproduced to an area near both the ears of the seated person, so much output sound pressure level of the drive speaker is not needed. Therefore, a drive speaker of a small bore diameter can be applied to the speaker unit, and the speaker unit itself can be made compact and light. The speaker unit is mounted on the backface side of the backrest of the seat, for example, and it is not necessary to take the trouble to ensure a place for placing the speaker unit around the seat. Accordingly, for example, when the speaker unit is mounted outside the seat of a vehicle, a narrow space inside the vehicle can be utilized effectively.

### BACKGROUND OF THE INVENTION

1. Field of the Invention

The present invention relates to a speaker unit for reproducing low-frequency sound, particularly mounted outside a seat of a vehicle or the like.

2. Description of Related Art

As a speaker unit for reproducing low-frequency sound, phase inversion type speaker units such as a bass-reflex type and a Kelton type are conventionally known.

For example, a bass-reflex type speaker unit includes a casing having a cavity inside, a so-called enclosure, a speaker for reproducing low-frequency sound provided on one side surface of the enclosure, and a duct provided on the same side surface. This duct is formed into a cylindrical shape, and connects an inside of the enclosure and an outside of the enclosure. At the time of reproducing sound, such a speaker unit inverts the phase of an acoustic wave emitted from a rear surface of a speaker diaphragm, and emits the acoustic wave to the outside of the enclosure via the duct. Thereby, the speaker unit intensifies the acoustic wave emitted to a front surface from the speaker diaphragm to make it possible to reproduce low-frequency sound.

As a speaker unit of this kind, there is proposed, for example, a speaker unit for reproducing low-frequency band sound in which distortion is reduced by making the phase characteristic flat in an actual use band and the sound image localization in a low-frequency band is improved (for example, refer to Japanese Patent Application Laid-Open under No. 2002-159083). There is also proposed a sub woofer box device which makes it possible to reproduce low heavy sound by relieving increase and decrease of pressure caused when a chamber has an enclosed structure, and further reduces the generation of abnormal sound (for example, refer to Japanese Patent Application Laid-Open under No. 9-275595).

There is proposed a sub woofer level adjustment device that can accurately adjust a level of a sub woofer (for example, refer to Japanese Patent Application Laid-Open under No. 2002-186087).

The aforementioned speaker units are frequently loaded especially on a vehicle and the like. The speaker units are usually placed in appropriate positions inside a vehicle, for example, in a vacant space in a rear part, a periphery of a seat or the like inside the vehicle. As a result, the speaker unit is installed in a position away from the ears of a seated person in the vehicle. Accordingly, such speaker unit needs to emit sufficient low-frequency sound to the ears of the seated person in the vehicle, and therefore a speaker with large output power is used.

However, since such a powerful speaker has a large bore diameter and a heavy magnetic circuit, the speaker unit itself has a large shape and is heavy. Therefore, there arises the problem that the speaker unit occupies a narrow space in a vehicle.

### SUMMARY OF THE INVENTION

As the problems to be solved by the present invention, those described above are cited as examples. The present invention has its object to provide a compact and light speaker unit for reproducing low-frequency sound, which is capable of being mounted outside a seat.

According to one aspect of the present invention, there is provided a speaker unit, including: a speaker device having a pair of acoustic tubes; a casing which houses the speaker device; and a mounting member which mounts the casing outside a seat, wherein ends of the pair of acoustic tubes are opened to an outside in a sound emitting surface of the casing which becomes a top surface when the casing is mounted outside the seat.

According to the above-described speaker unit, the speaker device, which includes a pair of acoustic tubes capable of reproducing low-frequency sound, for example, is housed in the casing, and the casing is mounted outside the seat of a vehicle or the like by a mounting member. In this case, the end portions of a pair of acoustic tubes are opened to the outside in the sound emitting surface of the casing, which becomes the top surface when the casing is mounted outside the seat. More preferably, each end portion of the pair of acoustic tubes is located in the vicinity of left and right ears of the seated person in the seat. Therefore, low-frequency sound can be reproduced to the area in the vicinity of both the ears of the seated person, at the time of driving the speaker unit.

Since the low-frequency sound can be reproduced to the area in the vicinity of both the ears of the seated person, the output sound pressure level of the speaker device is not needed so much. Therefore, a compact speaker device with a small bore diameter can be applied to the speaker unit, and the speaker unit itself can be made compact and light. Thereby, the shape or the like of the acoustic tube can be freely changed, and therefore it is possible to design a compact and light speaker unit. In this speaker unit, the lowest resonance frequency can be easily set by changing the length, the sectional area and the like of the acoustic tubes.

In one feature of the above-described speaker unit, the mounting members may be provided on left and right side surfaces neighboring the sound emitting surface of the casing, and may include mounting parts of a linear-shaped member for mounting the casing on the seat by winding the linear-shaped member around the seat. The mounting member may be provided on the sound emitting surface of the casing, and may include the mounting part of the linear-shaped member for hanging and holding the casing from an upper position of the seat. In that way, the speaker unit can reliably be fixed to the seat.

In another feature of the above-described speaker unit, end portions of the pair of acoustic tubes opened to the outside are preferably separated by a distance approximately equal to a distance between both ears of an average human being in the sound emitting surface of the casing. Thereby, when the speaker unit is mounted on the seat, the end portions of the pair of acoustic tubes can be precisely positioned near both ears of the seated person.

In addition, the above-mentioned speaker unit is mounted outside the seat with the end portions of the pair of acoustic tubes disposed near both ears of the seated person via the mounting part.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a perspective view of a construction of a speaker unit of the present invention;

FIG. 2 is a block diagram showing a method of supplying electric power and an audio signal to the speaker unit;

FIG. 3 is a diagram explaining a Helmholtz resonance frequency and a resonance frequency of an acoustic tube by the speaker unit;

FIG. 4 is a view schematically showing another example of the speaker unit;

FIG. 5 is a side view of a state in which the speaker unit is mounted on a front seat of a vehicle;

FIG. 6 is a plan view of a state in which the speaker units are mounted on the front seats of the vehicle;

FIG. 7 is an enlarged rear view of a state in which the speaker unit is mounted on the front seat of the vehicle;

FIG. 8 is a side view of a state in which the speaker unit is mounted on a backface side of a backrest of a chair for a personal computer; and

FIG. 9 is a rear view of a state in which the speaker units are mounted on the backface side of the backrests of the chairs in a beauty parlor.

### DETAILED DESCRIPTION OF THE PREFERRED EMBODIMENTS

The preferred embodiments of the present invention will now be described below with reference to the attached drawings.

The embodiments provide a compact and light speaker unit for reproducing low-frequency sound, which is capable of being mounted outside a seat.

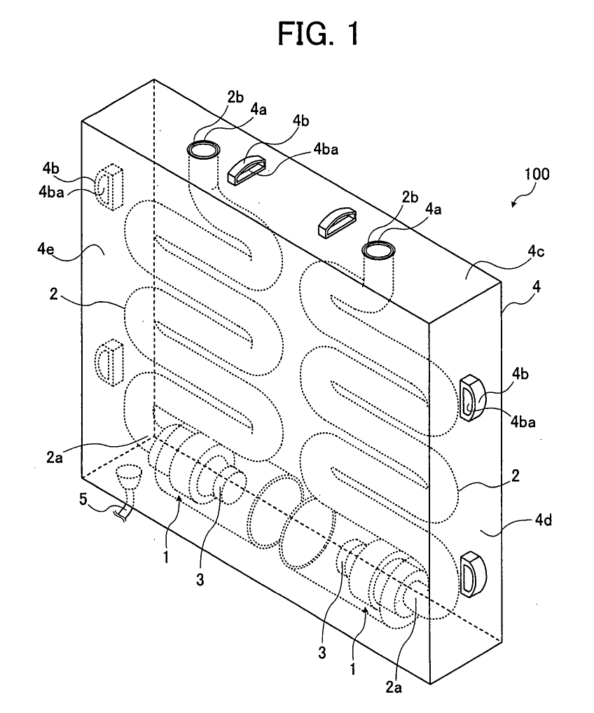

FIG. 1 schematically shows a construction of a speaker unit 100 according to an embodiment of the present invention. FIG. 1 shows a perspective view of the speaker unit 100. Hereinafter, the construction of the speaker unit 100 according to the embodiment of the present invention will be explained with reference to FIG. 1.

The speaker unit 100 includes an acoustic capacity portion 1, an acoustic tube 2, a drive speaker 3, wiring 5 and a casing 4 having a space inside. The speaker unit 100 is mounted outside various kinds of seats (including various kinds of chairs, the same thing will apply hereinafter) and used, as will be described later.

The acoustic capacity portion 1 is connected to an open end 2a of the acoustic tube 2 and a sound emitting side of the drive speaker 3, respectively.

The acoustic tube 2 has two open ends 2a and 2b. The one open end 2a is connected to the acoustic capacity portion 1 as described above, and the other open end 2b is connected to an upper surface 4c of the casing 4. A distance between the two open ends 2b is desired to be about the distance between both ears of an average human being, and it can be set at about 10 to 20 cm, for example. The acoustic tube 2 is formed into the curved shape to correspond to the size of the seat which will be described later and to emit low-frequency sound in a predetermined band, but the acoustic tube 2 is not limited to such a shape. Accordingly, the acoustic tube 2 can be formed into various kinds of shapes such as a U-shape and a linear shape as necessary.

The drive speaker 3 is preferably a compact and light speaker suitable for reproducing low-frequency sound. The wiring 5 is a wiring for supplying electric power and audio signals to the drive speaker 3 from a sound source which will be described later, or the like. The wiring 5 is connected to a voice coil (not shown) of the drive speaker 3.

The casing 4 is provided with openings 4a and mounting parts 4b. A plurality of openings 4a are formed on the upper surface 4c of the casing 4, and the position of each of the openings 4a corresponds to the position of the open end 2b of each of the acoustic tubes 2. A plurality of mounting parts 4b are formed on the upper surface 4c of the casing 4 and two side surfaces 4d and 4e neighboring the upper surface 4c respectively. A penetrating hole of a predetermined-shape 4ba is formed inside the mounting part 4b. The penetrating hole 4ba serves to mount the speaker unit 100 outside the seat by the fastening member such as a string.

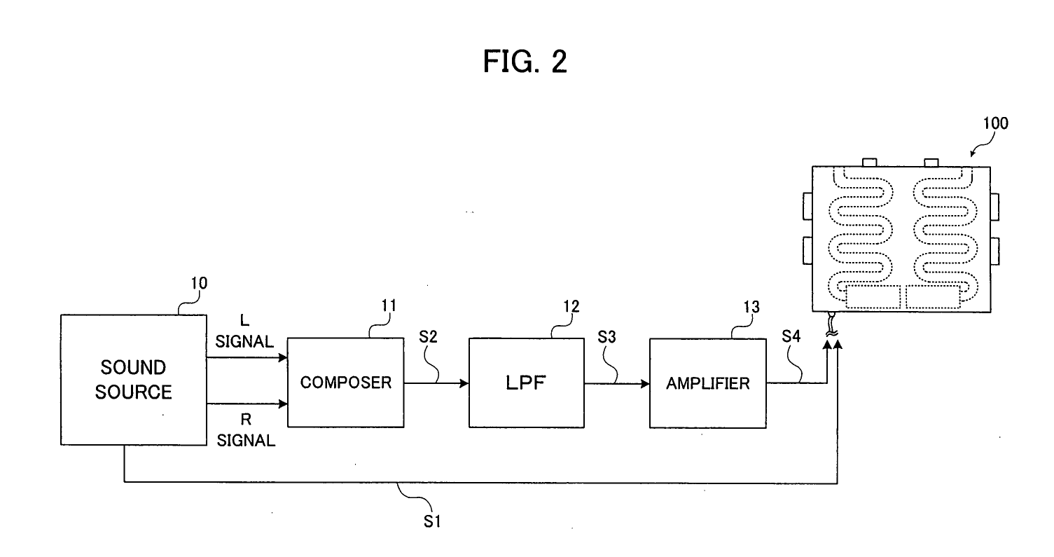

Next, with reference to FIG. 2, a method for supplying electric power and audio signals to the speaker unit 100 will be briefly described.

The electric power supply to the speaker unit 100 is performed through a sound source 10 as shown by the allow S1, for example. More specifically, the sound source 10 outputs electric power of a predetermined magnitude to the drive speaker 3 through the wiring 5 (signal S1). Thereby, electric power supply to the speaker unit 100 is performed. Meanwhile, supply of the audio signals to the speaker unit 100 is performed through the sound source 10, a composer 11, an LPF (Low Pass Filter) 12, and an amplifier 13.

The sound source 10 corresponds to a CD (Compact Disc) player, an MD (Mini Disc) player or the like. The sound source outputs left-right dual channel audio signals L and R to the composer 11. The composer 11 adds up the outputted L and R audio signals, and outputs the added (L+R) audio signal to the LPF 12 (signal S2). The LPF 12 cuts off a predetermined frequency component. More specifically, the LPF 12 extracts only an audio signal of a predetermined low frequency from the (L+R) audio signal outputted through the composer 11, and outputs the extracted audio signal to the amplifier 13 (signal S3). The amplifier 13 amplifies the extracted audio signal by a predetermined amplification factor, and outputs the amplified audio signal to the drive speaker 3 via the wiring 5 (signal S4). On receiving the supply of electric power and the audio signal through the sound source 10 or the like in this manner, the drive speaker 3 emits a low frequency-band acoustic wave to the acoustic capacity portion 1 through the diaphragm (not shown).

In this speaker unit 100, the acoustic capacity portion 1 and the acoustic tube 2 constitute a resonator of Helmholtz. As a result, the speaker unit 100 produces resonance at two resonance frequencies, i.e., the resonance frequency as the Helmholtz resonator by the acoustic capacity portion 1 and the acoustic tube 2, and the resonance frequency by the acoustic tube 2 itself.

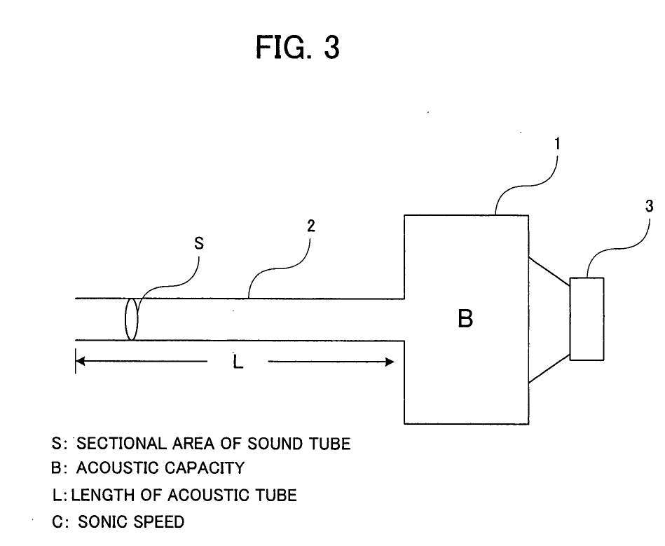

Here, FIG. 3 schematically shows the construction of the structure constituted of the acoustic capacity portion 1, the acoustic tube 2 and the drive speaker 3 which are housed in the speaker unit 100. In FIG. 3, the acoustic tube 2 in the curved shape is formed in the linear shape for convenience of explanation. When the length of the linearly shaped acoustic tube 2 is expressed as “L”, the sectional area of the acoustic tube 2 is expressed as “S”, the acoustic capacity of the acoustic capacity portion 1 is expressed as “B”, and the sonic speed is expressed as “C”, the Helmholtz resonance frequency “f0” and the resonance frequency “f” of the acoustic tube 2 by the speaker unit 100 are respectively obtained as follows.

Helmholtz Resonance frequency

$$f ∘ \frac{C}{2 π} \sqrt{\frac{S}{L B}}$$

Resonance frequency of a tube with both end opened

$$f = \frac{C}{2 L}$$

Resonance frequency of a tube with one end opened

$$f = \frac{C}{4 L}$$

It is noted that the resonance frequency of the acoustic tube 2 differs in the case that both ends of the acoustic tube 2 are opened and in the case that one end is opened.

When the air inside the acoustic capacity B is vibrated by the drive speaker 3, sound is emitted with the highest sound pressure from the open end 2b of the acoustic tube 2 at the Helmholtz resonance frequency, namely, the resonance frequency of the compliance of the acoustic capacity B and the air mass inside the acoustic tube 2. Since the acoustic capacity B exists at the right side of the acoustic tube 2 as shown in FIG. 3, the resonance frequency of the acoustic tube 2 occurs between the frequency in the case that both the ends are opened and the frequency in the case that one end is opened. In this case, sound is emitted from the open end 2b of the acoustic tube 2 at a predetermined higher frequency than the above-descried Helmholtz resonance frequency.

As a result, a frequency with a high sound pressure level can be obtained in a predetermined low-frequency sound range, for example, in the range of the lowest resonance frequency of, for example, 300 Hz or lower by the resonance of Helmholtz by the acoustic capacity portion 1 and the acoustic tube 2 and the resonance by the acoustic tube 2 itself, and hence the speaker unit 100 can be utilized as the speaker device for low-frequency sound. The lowest resonance frequency can be set at a predetermined value by setting the sectional area S and the length L of the acoustic tube 2, and the acoustic capacity B of the acoustic capacity portion 1 to an appropriate area, capacity and length, respectively as necessary.

In the above-described embodiment, in order to reproduce low-frequency sound of a suitable sound volume for the left and right ears of a seated person, a pair of structures each constructed by the acoustic capacity portion 1, the acoustic tube 2 and the drive speaker 3 are housed in the casing 4 to form the speaker device for reproducing low-frequency sound. However, the speaker device of the invention is not limited to this, and it is possible to properly change the number of structures housed in the casing 4 as necessary.

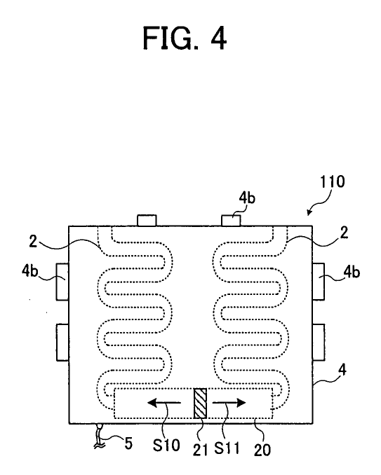

For example, as another example, a speaker unit for reproducing low-frequency sound provided with only one acoustic capacity portion and one drive speaker in the casing 4 can be constructed without changing the length, the sectional area, the shape and the placement of the acoustic tube 2. FIG. 4 schematically shows the construction of such a speaker unit 110.

The speaker unit 110 is provided with only one drive speaker 21 inside an acoustic capacity portion 20 as shown in FIG. 4. When electric power and an audio signal are supplied to the drive speaker 21 from the sound source 10 through the wiring 5 in the speaker unit 110 of this example, a diaphragm (not shown) of the drive speaker 21 vibrates in a major axis direction of the acoustic capacity portion 20, and low frequency-band acoustic waves are emitted from a front surface direction (the arrow S10) and a rear surface direction (the arrow S11) of the drive speaker 21 by the diaphragm, respectively. These acoustic waves are emitted to an outside through the acoustic capacity portion 20 and the open end 2b of each of the acoustic tubes 2, and low-frequency sound is reproduced by the speaker unit 110.

Incidentally, the speaker unit 110 is provided with only one drive speaker 21. Therefore, there is the possibility that a low-frequency sound with desired sound pressure is not reproduced sufficiently depending on the specified output sound pressure of the drive speaker 21. Accordingly, in order to reproduce a desired low-frequency sound sufficiently, it is preferable to apply, to the speaker unit 110, a speaker with a larger bore diameter of the diaphragm than in the aforesaid drive speaker 3, for example.

According to the above-mentioned speaker unit 100 of the present invention, since the plurality of mounting parts 4b are formed on the casing 4, the speaker unit 100 can easily be mounted outside the seat, e.g., at an upper position on the backface side of the backrest of the seat, by the mounting parts 4b. Thereby, a space for mounting the speaker unit 100 is unnecessary around the seat. Thus, when the speaker unit 100 is mounted on the backface side of the backrest of the seat in the vehicle, for example, the speaker unit 100 does not occupy a narrow space of the vehicle. Therefore, the speaker unit 100 can be applied to a light car having a narrow space inside, which can effectively be used.

When the speaker unit 100 is mounted outside the seat, e.g., at the upper position on the backface side of the backrest of the seat, the open ends 2b of the pair of the acoustic tube 2 are disposed near the left and right ears of the seated person respectively. Therefore, at the time of driving the speaker unit 100, the low-frequency sound can be reproduced near the left and right ears of the seated person. In addition, since the low-frequency sound can be reproduced near both ears of the seated person, the output sound pressure level of the drive speaker 3 is not needed so much. Therefore, the compact drive speaker 3 with the small bore diameter can be applied to the speaker unit 100, and the speaker unit 100 itself can be made compact and light.

Since the shape or the like of the acoustic tube 2 can be freely changed, it is possible to design the compact and light speaker unit.

Next, a method for mounting the speaker unit 100 of the present invention will be described. The speaker unit 100 of the present invention is used in the state in which it is mounted outside various kinds of seats of a vehicle, a personal computer, a beauty parlor and the like.

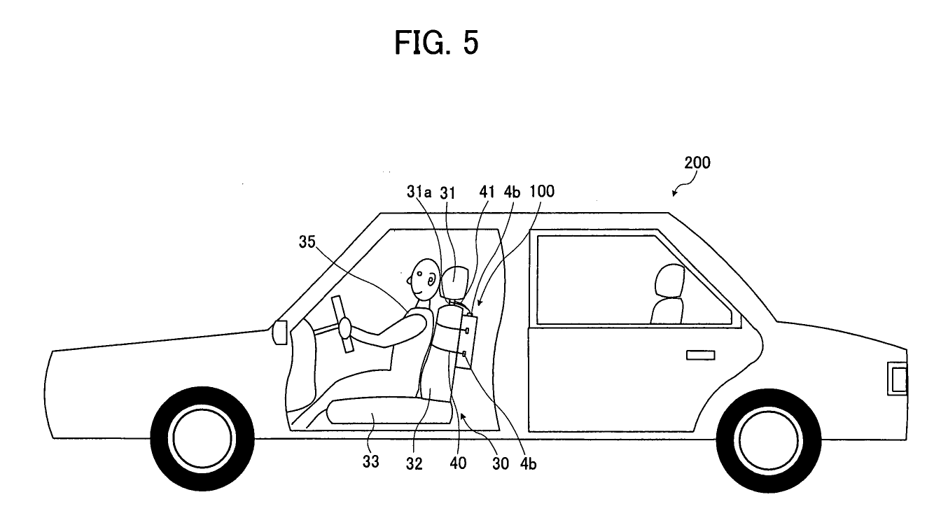

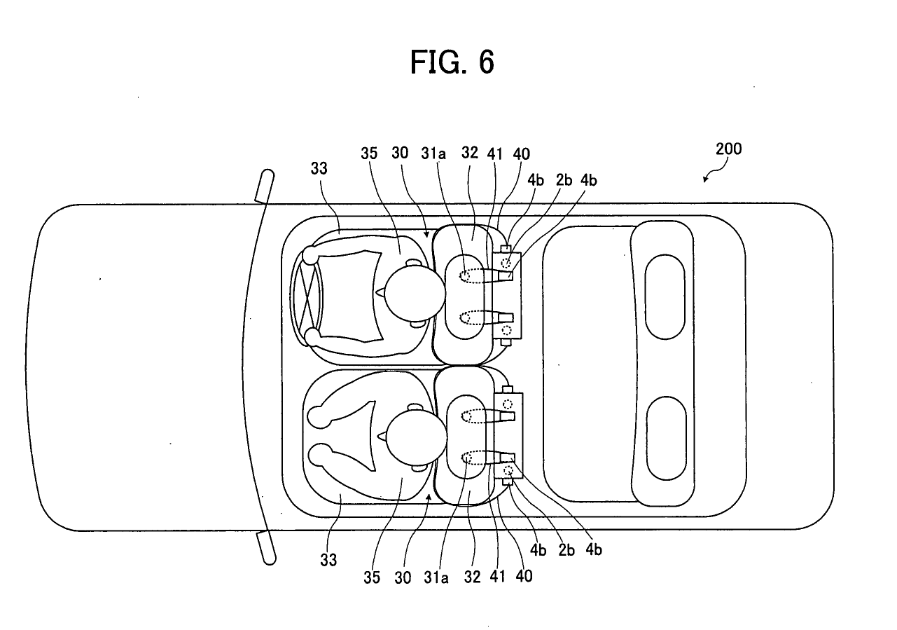

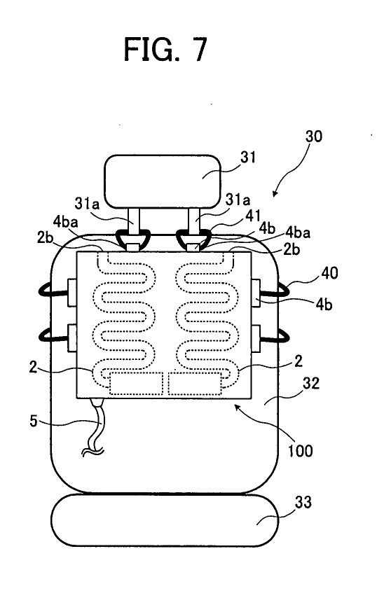

First, the description will be given of the method for mounting the speaker unit 100 of the present invention outside the seat of the vehicle. FIG. 5 to FIG. 7 show the state in which the speaker units 100 of the present invention are mounted outside front seats 30 of a driver's seat and a front passenger's seat of a vehicle 200. FIG. 5 shows a side view of the mounting state, and FIG. 6 shows a plan view of the mounting state. FIG. 7 shows a partly enlarged diagram in a state in which the speaker unit 100 is mounted on a backface side of a backrest 32 of the front seat 30. It is noted that, in FIG. 5 and FIG. 6, a front door and a roof part of the vehicle 200 are omitted from the illustration so that the state in which the speaker units 100 are mounted on the front seats 30 can be clearly shown.

The plurality of mounting parts 4b are formed on the casing 4 in the speaker unit 100 of the present invention, as described above. Further, each mounting part 4b has the penetrating hole 4ba. On the other hand, the front seat 30 of the vehicle 200 includes a head support part 31, the backrest 32 and a seat part 33. The head support part 31 has a connecting member 31a attachable to and detachable from the backrest 32.

In such the configuration, as understood from FIG. 5 to FIG. 7, the speaker unit 100 is mounted to the backface side of the backrest 32 of the front seat 30 by the mounting parts 4b. Concretely, first, a linear or band-shaped fastening member 41 such as a string, a rope and a band is inserted to the penetrating hold 4ba of each mounting part 4b formed on the sound emitting surface of the casing 4, i.e., on the upper surface 4c. Then, the fastening member 41 is hung on the connecting member 31a, and each mounting part 4b and the connecting member 31a are indirectly connected to each other via the fastening member 41. Thereby, the speaker unit 100 is maintained to be hung on the backface of the front seat 30 by the linear or band-shaped fastening member 41, and the open ends 2b of the respective acoustic tubes 2 are disposed near both ears of the seated person 35.

The fastening member 40 is connected to the speaker unit 100, and parts (not shown) attachable to and detachable from the respective ends are connected to the both ends of the fastening member 40. Therefore, by connecting the respective parts which are connected to the respective ends of the fastening member 41, the respective mounting parts 4b formed on the upper surface 4c of the casing 4 can be indirectly connected to the connecting member 31a. Instead, both ends of the linear fastening member 41 may be connected to the mounting part 4b.

Next, the linear or band-shaped fastening members 40 are inserted to the respective mounting parts 4b formed on the side surfaces 4d and 4e of the casing 4. In this case, the fastening member 40 may be the string, the rope, the gum band and the like, too. By winding the fastening member 40 connected to the speaker unit 100 around the front seat 30, the speaker unit 100 can be attached on the backface of the front seat 30. In that way, as shown in FIG. 5 to FIG. 7, the speaker unit 100 can reliably be fixed to the backface side of the backrest of the front seat 30 with the open ends 2b of the respective acoustic tubes 2 disposed near both ears of the seated person 35.

As described above, the speaker unit 100 can easily be mounted outside the seat by the plurality of mounting parts 4b formed on the casing 4. In addition, when the speaker unit 100 is mounted outside the seat, the open ends 2b of the respective acoustic tubes 2 are disposed near both ears of the seated person. In other word, the open ends 2b of the respective acoustic tubes 2 in the speaker unit 100 are disposed on the upper surface 4c of the casing 4 corresponding to the top surface in a case that the speaker unit 100 is mounted on the seat, and the upper surface 4c becomes the sound emitting surface. Accordingly, since the low-frequency sound can be reproduced near both ears of the seated person, the output sound pressure level of the drive speaker 3 is not needed so much. Thus, the compact drive speaker 3 with the small bore diameter can be applied to the speaker 100, and the speaker unit 100 itself can be made compact and light. A study experimentally proves that low-frequency sound reproduction near the ears gives a listener no unpleasant auditory feeling.

According to the method for mounting the speaker unit 100 of the present embodiment, the speaker unit 100 can selectively be mounted on the driver's seat or the front passenger's seat. Thereby, the speaker unit 100 can be mounted only on the seat of the seated person 35 fond of the low-frequency sound reproduction, for example.

Moreover, since the output sound pressure level of the drive speaker 3 applied to the speaker unit 100 of the present invention is not so large, even if the speaker unit 100 mounted on both the driver's seat and the front passenger's seat are simultaneously used, the low-frequency sound emitted from one of the speaker units 100 is hardly heard by the neighborly seated person 35. Thus, the seated person 35 in each seat can listen to the appropriate low-frequency sound. Therefore, the speaker unit 100 can be effectively used when the seated person enjoys the low-frequency sound reproduction in a car such as an open car and a two seater.

Next, the examples in which the speaker unit 100 of the present invention is applied to the chair for a personal computer, the chair of a beauty parlor and the like will be described.

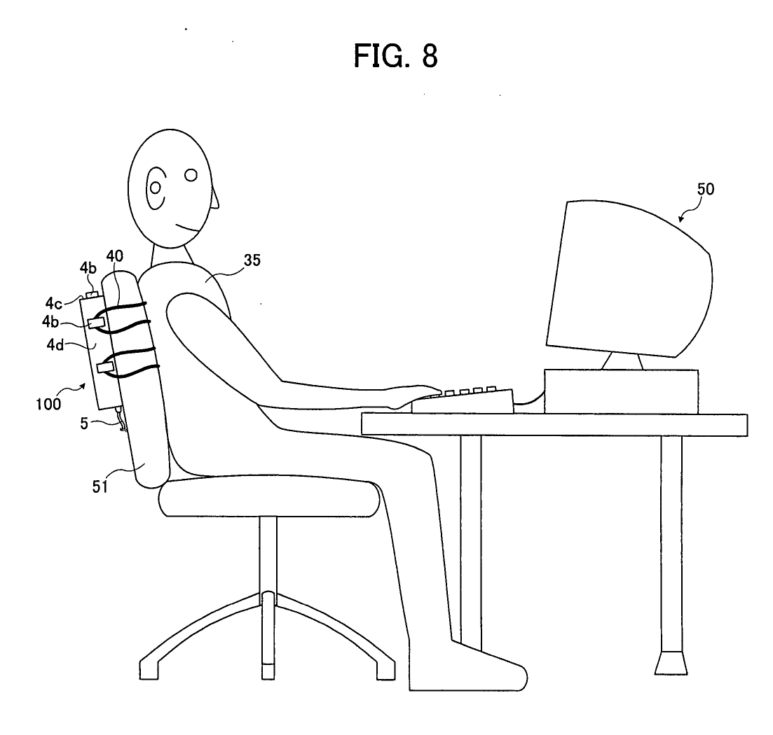

FIG. 8 shows a side view of a state in which the speaker unit 100 is mounted on the backface side of the backrest of a chair 51 for a personal computer 50 based on the above-described method. In this example, the mounting parts 4b formed on the upper surface 4c of the casing 4 are not used, and the speaker unit 100 is mounted on the backface side of the backrest of the chair 51 for the personal computer 50 only by the mounting parts 4b, which are formed on the side surfaces 4d and 4e of the casing 4 respectively, and fastening members 40. When a head support part and a projecting part are formed on the chair 51, the mounting parts 4b formed at the upper position of the casing 4 can be used, identically to the application example to the above-mentioned seat of the vehicle.

Like this, by suitably using the mounting parts 4b in accordance with various kinds of shapes of chairs, the open ends 2b of the respective acoustic tubes 2 are also reliably disposed near both ears of the seated person 35. In this example, a surround system is constructed by a speaker attached to the personal computer 50 and the speaker unit 100 of the present invention. Accordingly, the seated person 35 can enjoy DVDs (Digital Video Disc) and games with the sound having realism by such a surround system.

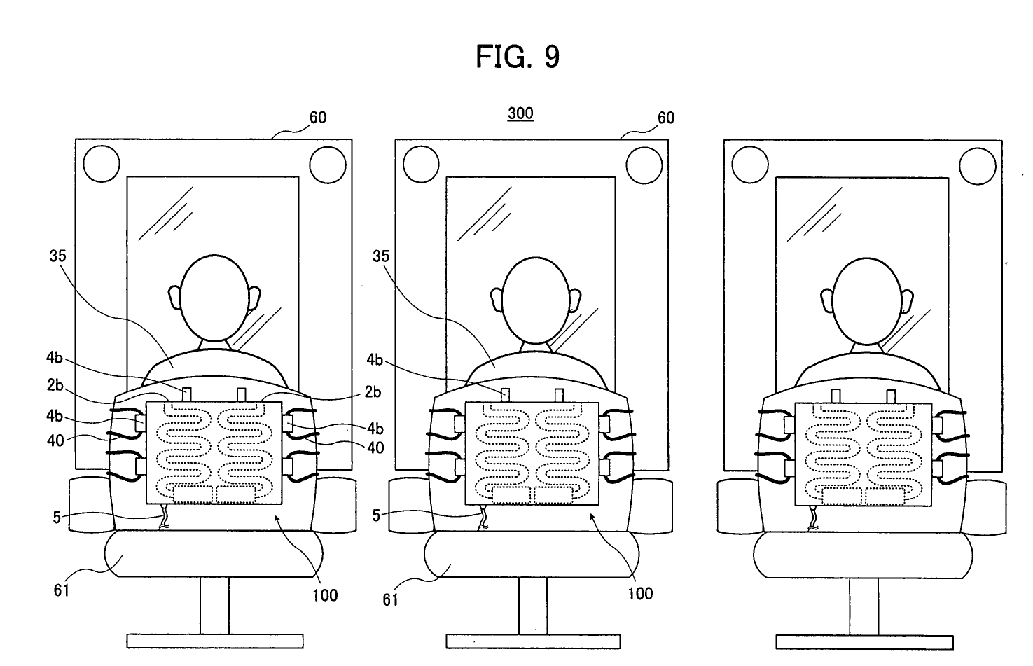

Next, FIG. 9 shows the state in which the speaker unit 100 is mounted on the backface side of the backrest of a chair 61 of a beauty parlor 300 according to the above-described same method, as a rear view. As shown in FIG. 9, the seated person 35 is seated in the chair 61 facing to a dressing table 60, and the speaker unit 100 is mounted on the backface side of the backrest of the chair 61. In this case, the open ends 2b of the respective acoustic tubes 2 are reliably disposed near both ears of the seated person 35. Accordingly, the speaker unit 100 is driven while the seated person 35 is having a haircut or having his or her hair permanently waved, whereby the seated person 35 can spend such a time comfortably. In this case, when the head support part and the projecting part are formed at the upper position of the chair 61, the mounting part 4b and the like formed on the casing 4 can be used, identically to the above application example to the seat of the vehicle.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-390595 filed on Nov. 20, 2003 including the specification, claims, drawings and summary is incorporated herein by reference in its entirety.

1. A speaker unit, comprising:
a speaker device comprising a pair of acoustic tubes;
a casing which houses said speaker device; and
a mounting member which mounts said casing outside a seat,
wherein ends of said pair of acoustic tubes are opened to an outside in a sound emitting surface of said casing which becomes a top surface when said casing is mounted outside the seat.

2. The speaker unit according to claim 1, wherein each end portion of said pair of acoustic tubes is positioned in the vicinity of left and right ears of a seated person in the seat.

3. The speaker unit according to claim 1, wherein said mounting members are provided on left and right side surfaces neighboring the sound emitting surface of said casing, and comprise mounting parts of a linear-shaped member for mounting said casing on the seat by winding the linear-shaped member around the seat.

4. The speaker unit according to claim 1, wherein said mounting member is provided on the sound emitting surface of said casing, and includes mounting parts of a linear-shaped member for hanging and holding said casing from an upper position of the seat.

5. The speaker unit according to claim 2, wherein the end portions of said pair of acoustic tubes opened to the outside are separated by a distance approximately equal to a distance between both ears of an average human being in the sound emitting surface of said casing.
